(19) United States
(12) Patent Application Publication
(10) Pub. No.: US 2014/0262479 A1
(43) Pub. Date: Sep. 18, 2014

(54) STRAP FOR POSITIONING WIRES/CABLES

(71) Applicant: Varujan Abalian, Lexington, MA (US)

(72) Inventor: Varujan Abalian, Lexington, MA (US)

(21) Appl. No.: 14/208,815

(22) Filed: Mar. 13, 2014

Related U.S. Application Data
(60) Provisional application No. 61/784,530, filed on Mar. 14, 2013.

(51) Int. Cl. H02G 3/30; H02G 1/06

(52) U.S. Cl. CPC H02G 3/30; H02G 1/06
USPC 174/480; 52/741.1

(57) ABSTRACT

An illustrative embodiment of the present invention relates to a strap for maintaining the position of wires/cables within a wall frame. The strap has an elongate flexible strip which includes a first plurality of apertures between a first end and a second opposite end of the strip. The strap also includes a second plurality of apertures disposed along the strip between the first end and the second end. Also, the strap includes flexible tabs formed by intersecting slits passing completely through the flexible strip in such a way as to form wire/cable engaging sections. Each wire/cable engaging section is configured for holding a wire/cable placed therethrough while resisting unintentional dislodging of such wire/cable.

### RELATED APPLICATION

This application claims priority to, and the benefit of, co-pending U.S. Provisional Application No. 61/784,530 filed Mar. 14, 2013, for all subject matter common to both applications. The disclosure of said provisional application is hereby incorporated by reference in its entirety.

### FIELD OF THE INVENTION

The present invention relates to support brackets suitable for positioning wires/cables, and more particularly to a strap having wire/cable engaging sections for holding wires/cables in place during installation.

### BACKGROUND

During construction of a building (i.e. house) or renovation of a room within a building, exposed framing members (i.e. studs, rafters, etc.) are used for supporting wall surfaces of a room. Electrical wiring, speaker wires/cables, television cables, computer cables, and other low voltage as well as line voltage wiring and cabling, are routed to a region, typically between framing members such as studs or other framing members, where an electrical box is to be located. At times, after the wall surfaces are attached to the framing members such as studs, openings are cut into the wall material of the wall surfaces and the electrical box or other direct wired devices or fixtures are installed.

Conventionally, the electrical box is fastened to the side of the framing members such as studs or other framing members. Wires/cables are then coupled with the electrical box and can be connected from the electrical box to an electrical device for running equipment such as a computer, television, telephone, or the like.

In most instances, these wires or cables are installed well before the wall surfaces are positioned, and therefore when there is no destination electrical box (e.g., such as with a thermostat, speaker, vanity light, etc.). Keeping a wire or cable in position without the electrical box in place is difficult. Also, it can be cumbersome to locate the desired wires or cables through a solid wall board of the wall surface, especially where there is no nearby electrical box.

### SUMMARY

There is a need for a device that is able to position and organize wires/cables at certain regions/locations of a wall frame prior to installation of a wall surface or other covering over the framing members in the wall frame, and prior to installation of an electrical box or fixture to which the wire/cable is planned for eventual connection. The present invention is directed toward further solutions to address this need, in addition to having other desirable characteristics.

In accordance with an embodiment of the present invention, a strap for positioning wires/cables within a wall frame has an elongate flexible strip having a first end and a second end opposite the first end. The strap includes a first plurality of apertures passing through the flexible strip and disposed along the strip between the first end and the second end. The first plurality of apertures are positioned generally proximal to a first lengthwise edge of the strip. The strap also includes a second plurality of apertures passing through the flexible strip and disposed along the strip between the first end and the second end. The second plurality of apertures are positioned generally proximal to a second lengthwise edge of the strip. The second lengthwise edge being opposite the first lengthwise edge. Also, the strap includes a plurality of flexible tabs formed by intersecting slits passing completely through the flexible strip in such a way as to form a plurality of wire/cable engaging sections. The plurality of wire/cable engaging sections are positioned generally along a center portion of the strip between the first end and the second end. Each wire/cable engaging section is configured for holding a wire/cable placed therethrough.

In accordance with aspects of the present invention, the strap includes a plurality of perforation lines extending between the first lengthwise edge and the second lengthwise edge of the strip in such a way as to form a tear line suitable for separating the elongate flexible strip into separate sections by ripping the strip along one of the plurality of perforation lines. In a further aspect, one perforation line of the plurality of perforation lines is positioned between two consecutive wire/cable engaging sections of the plurality of wire/cable engaging sections.

In accordance with aspects of the present invention, each of the first plurality of apertures and the second plurality of apertures is sized and dimensioned to receive a fastener suitable for coupling the strap to a framing member of the wall frame. In a further aspect, the fastener is a nail, screw, or staple.

In accordance with aspects of the present invention, the strip includes a flexible material. The flexible material can include non-conductive material, fire resistant material, plastic material, rubber material, composite material, nylon material, or synthetic material.

In accordance with one aspect of the present invention, each aperture of the first plurality of apertures is spaced at a recurring interval. In another aspect, each aperture of the second plurality of apertures is spaced at a recurring interval. In another aspect, each wire/cable engaging section of the plurality of wire/cable engaging sections is spaced at a recurring interval.

In accordance with aspects of the present invention, two consecutive apertures of the first plurality of apertures are positioned opposite two consecutive apertures of the second plurality of apertures in such a way that a wire/cable engaging section of the plurality of wire/cable engaging sections is disposed between the two consecutive apertures of the first plurality of apertures and the two consecutive apertures of the second plurality of apertures.

In accordance with aspects of the present invention, the plurality of flexible tabs of each wire/cable engaging section have sufficient elasticity to flex when a wire/cable is placed through each wire/cable engaging section causing a force to be applied against the wire/cable in such a way as to create a friction fit between the wire/cable and each wire/cable engaging section.

In accordance with one aspect of the present invention, each wire/cable engaging section of the plurality of wire/cable engaging sections has a consistent size and dimension configured to receive and form a friction fit with wires/cables of different cross-sectional areas. In another aspect, each wire/cable engaging section of the plurality of wire/cable engaging sections has a consistent size and dimension configured to receive and form a friction fit with wires/cables of different cross-sectional shapes.

In accordance with one aspect of the present invention, the elongate flexible strip can have a width between about 1.5 inches and about 2 inches.

In accordance with one aspect of the present invention, the intersecting slits form a substantially shape such that the flexible tabs are substantially pie-shaped.

In accordance with one aspect of the present invention, the strap includes a plurality of perforation lines extending between the first lengthwise edge and the second lengthwise edge of the strip. The plurality of perforation lines are about 1 inch from one another.

In accordance with aspects of the present invention, the wire/cable is a bare wire/cable. In one aspect, the wire/cable further includes a sheath covering and insulating the bare wire/cable.

In accordance with one aspect of the present invention, the wire/cable has a cross-sectional shape that is triangular, rectangular, or hexagonal.

In accordance with an embodiment of the present invention, a method of using a strap to maintain wires and/or cables within a wall frame includes providing a strap. The strap includes an elongate flexible strip having a first end and a second end opposite the first end: A first plurality of apertures pass through the flexible strip and are disposed along the strip between the first end and the second end. The first plurality of apertures are positioned generally proximal to a first lengthwise edge of the strip. A second plurality of apertures pass through the flexible strip and are disposed along the strip between the first end and the second end. The second plurality of apertures are positioned generally proximal to a second lengthwise edge of the strip. The second lengthwise edge is opposite the first lengthwise edge. The strap includes a plurality of flexible tabs formed by intersecting slits passing completely through the flexible strip in such a way as to form a plurality of wire/cable engaging sections. The plurality of wire/cable engaging sections are positioned generally along a center portion of the strip between the first end and the second end. Each wire/cable engaging section is configured for holding a wire/cable placed therethrough. The strap is affixed on the wall frame at a desired position between at least two framing members. At least one wire/cable is routed through the plurality of wire/cable engaging sections of the strap such that each wire/cable engaging section provides a friction fit with the at least one wire/cable. The at least one wire/cable is maintained at the desired position using the strap.

### BRIEF DESCRIPTION OF THE FIGURES

These and other characteristics of the present invention will be more fully understood by reference to the following detailed description in conjunction with the attached drawings, in which:

FIG. 1 is a front view of a strap for positioning wires/cables, according to an embodiment of the present invention;

FIG. 2 is a semi cross-sectional side view of the strap of FIG. 1 attached to a framing member of a wall frame for holding a wire/cable, according to one aspect of the present invention;

FIG. 3 is a close-up front view of a wire/cable engaging section of the strap of FIG. 1 holding a wire/cable, according to one aspect of the present invention;

FIG. 4 is a cross-sectional view of three wires/cables having different cross-sectional shapes, according to aspects of the present invention; and

FIG. 5 is a diagrammatic view of a wall frame showing installation of the strap of FIG. 1 within the wall frame, according to one aspect of the present invention.

### DETAILED DESCRIPTION

An illustrative embodiment of the present invention relates to a strap for maintaining the position of wires/cables within a wall frame and between framing members. The strap has an elongate flexible strip that includes a first group of apertures (i.e., plurality of apertures) between a first end and second opposite end of the strip. Also, the strap includes a second group of apertures (i.e., plurality of apertures) disposed along the strip between the first end and second end. The flexibility of the strip enables the strip to be stored in a rolled configuration prior to use. The strap also includes flexible tabs formed by intersecting slits passing completely through the flexible strip in such a way as to form wire/cable engaging sections. These wire/cable engaging sections are configured and allow for grasping or holding onto wires/cables having a variety of different diameters, which are placed therethrough. Thus, use of the strap (particularly the wire/cable engaging sections) allows a user to position and organize the wires/cables at certain desired regions/locations prior to installation of a wall surface or other covering.

FIGS. 1 through 5, wherein like parts are designated by like reference numerals throughout, illustrate example embodiments of a strap for maintaining the position of wires and/or cables in a wall frame according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, such as the size, shape, or type of elements or materials, in a manner still in keeping with the spirit and scope of the present invention.

Referring now to FIG. 1, a strap 10 for maintaining the position of wires/cables within a wall frame is depicted according to an example embodiment of the present invention. The strap 10 includes an elongate flexible strip 12 having a first end 14 and a second end 16 opposite the first end 14. The strip 12 includes a flexible material. For example, the flexible material can be plastic, rubber, composite, nylon, or synthetic material. The flexible material can include material having the properties of non-conductive and/or fire-resistant. The strip 12 has a measured width of W. For example, in certain illustrative implementations, the measured width W is about 1.5 inches to about 2 inches. However, one of skill in the art will appreciate that other widths W for the strip 12 are possible, and are considered to fall within the scope of the present invention.

The strap 10 includes a first plurality of apertures 18A that pass through the flexible strip 12 and are disposed along the strip 12 between the first end 14 and the second end 16. The first plurality of apertures 18A are positioned at a distance generally proximal to a first lengthwise edge 20A of the strip 12. Each of the first plurality of apertures 18A is spaced at a recurring interval as shown in FIG. 1.

The strap 10 also includes a second plurality of apertures 18B that pass through the flexible strip 12 and are disposed along the strip 12 between the first end 14 and the second end 16. The second plurality of apertures 18B are positioned at a distance generally proximal to a second lengthwise edge 20B of the strip 12. The second lengthwise edge 20B is opposite the first lengthwise edge 20A. Each of the second plurality of apertures 18B is spaced at a recurring interval as shown in FIG. 1. However, those of skill in the art will appreciate that the interval between each aperture can vary, or can differ according to a pattern, such that the present invention is by no means limited to apertures formed at a recurring interval.

In addition, the strap 10 includes flexible tabs 22. The flexible tabs 22 can be formed by intersecting slits 24 disposed in the strip 12. The flexible tabs 22 or flaps are arranged adjacent to one another and are resiliently deflectable outwardly from the strap 10 to define an opening that receives a wire/cable in such a way that the wire/cable extends through the strap 10 and is held in place via a friction fit. In one example, the intersecting slits form a “+” shape. The “+” shape includes the flexible tabs 22 arranged in a pie-shaped configuration with each flexible tab 22 or flap having converging lateral sides. However, other shapes can be used for the flexible tabs 22 or slits 24 as would be appreciated by one of skill in the art.

The intersecting slits 24 pass completely through the flexible strip 12 in such a way as to form wire/cable engaging sections 26. The wire/cable engaging sections 26 are positioned generally along a center portion of the strip 12 between the first end 14 and the second end 16. Each wire/cable engaging section 26 is configured for holding a wire/cable placed through the engaging section 26. Each wire/cable engaging section 26 is spaced at a recurring interval as shown in FIG. 1. However, those of skill in the art will again appreciate that the wire/cable engaging sections 26 can be positioned at varying distances from each other, or at different distances according to a pattern, such that the present invention is by no means limited to positioning the wire/cable engaging sections 26 only at recurring intervals.

The strap 10 also includes perforation lines 28. The perforation lines 28 extend between the first lengthwise edge 20A and the second lengthwise edge 20B of the strip 12. Each perforation line 28 forms a tear line suitable for separating the elongate flexible strip 12 into separate sections by ripping the strip 12 along one or more of the perforation lines 28. In one example, the perforation line 28 is positioned between two consecutive wire/cable engaging sections 26. Thus, the strap 10 may be provided to a user as a rolled up strip similar to rolled up tape (not shown, but readily appreciable by those of skill in the art). The user can select the desired length of strip 12 for a particular installation, un-roll that length from the roll, and rip the strip 12 along the perforation line 28 to result in a strip 12 of the desired length.

As shown in FIG. 1, the first plurality of apertures 18A, second plurality of apertures 18B, and the wire/cable engaging sections 26 have a specific arrangement with respect to one another, in accordance with one example embodiment. Between two perforation lines 28, two consecutive first apertures 18A are positioned opposite two consecutive second apertures 18B in such a way that a wire/cable engaging section 26 is disposed between the two consecutive first apertures 18A and two consecutive second apertures 18B. This arrangement or pattern may be repeated multiple times along the strip 12. The strip 12 has a measured length L between two perforation lines 28. For example, the measured length L can be about 1 inch. However, other lengths L can be used as would be readily appreciated by one of skill in the art and considered to be within the scope of the present invention.

FIG. 2 depicts the strap 10 attached directly to a framing member 31 such as a stud of a wall frame 30 for holding a wire/cable 32 covered by a sheath 33. In this example, the wire/cable 32 is insulated with a sheath 33. Alternatively, the wire/cable 32 is a bare wire/cable with no insulation or sheath. Each of the first plurality of apertures 18A and each of the plurality of second apertures 18B is sized and dimensioned to receive a fastener 34. The fasteners 34 are used for coupling the strap 10 to the framing member 31 of the wall frame 30. In one example, the framing member 31 is a wooden 2×4 stud. The fastener 34 can be, for example, a nail, screw, or staple. In the FIG. 2 example, the fasteners 34 are nails used to affix the strap 10 to one the framing members 31 of the wall frame 30.

The flexible tabs 22 of each wire/cable engaging section 26 have sufficient elasticity to flex when a wire/cable 32 is placed through the wire/cable engaging section 26, but not so flexible as to not be able to provide the necessary force against the wire/cable 32 to create the friction fit required to hold the wire/cable 32 in place. As shown in FIG. 3, the flexible tabs 22 or flaps apply a force against the wire/cable 32 in such a way as to create a friction fit between the wire/cable 32 and the flexible tabs 22 of the wire/cable engaging section 26 reducing the likelihood of the wire/cable 32 being disengaged from its position during installation of wall surfaces.

Each wire/cable engaging section 26 has flexible tabs 22 that have a consistent size and dimension configured to receive and form a friction fit with wires/cables 32 of different cross-sectional areas. More particularly, each wire/cable engaging section 26 has flexible tabs 22 that have a consistent size and dimension configured to receive and form a friction fit with different shaped wires/cables 32A, 32B, 32C as shown in FIG. 4, each of which has a different cross-sectional shape and area dimension. For example, the wire/cable 32 can have a triangular shape 32A, rectangular shape 32B, or hexagonal shape 32C. The ability of the wire/cable engaging section 26 to flex as the wire/cable 32 is pushed therethrough, results in the ability of the wire/cable engaging section 26 to receive and hold a number of different types of wires and cables having various sizes and dimensions, and therefore various cross-sectional areas, all with the same size and dimension of the wire/cable engaging section 26.

FIG. 5 depicts use of the strap 10 within the wall frame 30. In this example, the strap 10 is positioned within the wall frame 30 between framing members 31 such as studs of the wall frame 30. This stage of construction is before wall surfaces such as sheetrock panels or wall board are attached to the framing members 31 of the wall frame 30. Wires/cables 32 are routed to a desired inter-wall frame or inter-stud region and held in a desired position using the strap 10. For example, a wire/cable 32 is positioned within the wall frame 30 via the strap 10. In particular, a section of the wire/cable 32 is inserted through the wire/cable engaging section 26 at a desired location. The section of the wire/cable 32 is held tightly within the wire/cable engaging section 26 after being inserted via the friction fit. The strap 10 can also be used for maintaining the position of a wire/cable 32 at other desired locations, such as attached to rafters near a ceiling of a room, or other areas where the strap 10 can be fastened.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A strap for maintaining the position of wires and/or cables within a wall frame, the strap comprising:
an elongate flexible strip having a first end and a second end opposite the first end;
a first plurality of apertures passing through the flexible strip and disposed along the strip between the first end and the second end, wherein the first plurality of apertures are positioned generally proximal to a first lengthwise edge of the strip;
a second plurality of apertures passing through the flexible strip and disposed along the strip between the first end and the second end, wherein the second plurality of apertures are positioned generally proximal to a second lengthwise edge of the strip, the second lengthwise edge being opposite the first lengthwise edge; and
a plurality of flexible tabs formed by intersecting slits passing completely through the flexible strip in such a way as to form a plurality of wire/cable engaging sections, the plurality of wire/cable engaging sections positioned generally along a center portion of the strip between the first end and the second end, wherein each wire/cable engaging section is configured for holding a wire/cable placed therethrough.

2. The strap of claim 1, further comprising a plurality of perforation lines extending between the first lengthwise edge and the second lengthwise edge of the strip in such a way as to form a tear line suitable for separating the elongate flexible strip into separate sections by ripping the strip along one of the plurality of perforation lines.

3. The strap of claim 2, wherein one perforation line of the plurality of perforation lines is positioned between two consecutive wire/cable engaging sections of the plurality of wire/cable engaging sections.

4. The strap of claim 1, wherein each of the first plurality of apertures and the second plurality of apertures is sized and dimensioned to receive a fastener suitable for coupling the strap to a framing member of the wall frame.

5. The strap of claim 4, wherein the fastener is selected from the group consisting of nails, screws, and staples.

6. The strap of claim 1, wherein the strip is comprised of a flexible material selected from the group consisting of non-conductive material, fire resistant material, plastic material, rubber material, composite material, nylon material, and synthetic material.

7. The strap of claim 1, wherein each aperture of the first plurality of apertures is spaced at a recurring interval.

8. The strap of claim 1, wherein each aperture of the second plurality of apertures is spaced at a recurring interval.

9. The strap of claim 1, wherein each wire/cable engaging section of the plurality of wire/cable engaging sections is spaced at a recurring interval.

10. The strap of claim 1, wherein two consecutive apertures of the first plurality of apertures are positioned opposite two consecutive apertures of the second plurality of apertures in such a way that a wire/cable engaging section of the plurality of wire/cable engaging sections is disposed between the two consecutive apertures of the first plurality of apertures and the two consecutive apertures of the second plurality of apertures.

11. The strap of claim 1, wherein the plurality of flexible tabs of each wire/cable engaging section have sufficient elasticity to flex when a wire/cable is placed through each wire/cable engaging section causing a force to be applied against the wire/cable in such a way as to create a friction fit between the wire/cable and each wire/cable engaging section.

12. The strap of claim 1, wherein each wire/cable engaging section of the plurality of wire/cable engaging sections having a consistent size and dimension is configured to receive and form a friction fit with wires/cables of different cross-sectional areas.

13. The strap of claim 1, wherein each wire/cable engaging section of the plurality of wire/cable engaging sections having a consistent size and dimension is configured to receive and form a friction fit with wires/cables of different cross-sectional shapes.

14. The strap of claim 1, wherein the elongate flexible strip has a width between about 1.5 inches and about 2 inches.

15. The strap of claim 1, wherein the intersecting slits form a substantially “+” shape such that the plurality of flexible tabs are substantially pie-shaped.

16. The strap of claim 1, further comprising a plurality of perforation lines extending between the first lengthwise edge and the second lengthwise edge of the strip, wherein the plurality of perforation lines are about 1 inch from one another.

17. The strap of claim 1, wherein the wire/cable is a bare wire/cable.

18. The strap of claim 17, wherein the wire/cable further comprises a sheath covering and insulating the bare wire/cable.

19. The strap of claim 1, wherein the wire/cable has a cross-sectional shape selected from the group consisting of triangular, rectangular, and hexagonal.

20. A method of using a strap to maintain wires and/or cables within a wall frame, the method comprising:
providing a strap, wherein the strap comprises:
an elongate flexible strip having a first end and a second end opposite the first end;
a first plurality of apertures passing through the flexible strip and disposed along the strip between the first end and the second end, wherein the first plurality of apertures are positioned generally proximal to a first lengthwise edge of the strip;
a second plurality of apertures passing through the flexible strip and disposed along the strip between the first end and the second end, wherein the second plurality of apertures are positioned generally proximal to a second lengthwise edge of the strip, the second lengthwise edge being opposite the first lengthwise edge; and
a plurality of flexible tabs formed by intersecting slits passing completely through the flexible strip in such a way as to form a plurality of wire/cable engaging sections, the plurality of wire/cable engaging sections positioned generally along a center portion of the strip between the first end and the second end, wherein each wire/cable engaging section is configured for holding a wire/cable placed therethrough;
affixing the strap on the wall frame at a desired position between at least two framing members;
routing at least one wire/cable through the plurality of wire/cable engaging sections of the strap such that each wire/cable engaging section provides a friction fit with the at least one wire/cable; and
maintaining the at least one wire/cable at the desired position using the strap.
